(19) United States
(12) Patent Application Publication
(10) Pub. No.: US 2026/0138506 A1
(43) Pub. Date: May 21, 2026

(54) CHILD SEAT INTEGRAL HARNESS BELT TENSIONING AND LOAD LIMITATION

(71) Applicant: Britax Child Safety, Inc., Fort Mill, SC (US)

(72) Inventors: Martin Haas, Fort Mill, SC (US); Richard Henseler, Fort Mill, SC (US); Marcel Brenner, Fort Mill, SC (US); Richard Frank, Fort Mill, SC (US)

(21) Appl. No.: 19/392,714

(22) Filed: Nov. 18, 2025

Related U.S. Application Data
(60) Provisional application No. 63/721,832, filed on Nov. 18, 2024.

(51) Int. Cl. B60N 2/28; B60R 22/195; B60R 22/44

(52) U.S. Cl. CPC B60N 2/2812; B60N 2/2816; B60R 22/1954; B60R 22/44

(57) ABSTRACT

An integral harness belt tensioning and load limitation system for a child seat is provided. The integral harness belt tensioning system includes a belt tensioner and a belt force load limiter that is in the load path of the integral harness. The harness belt tensioning mechanism is activated by a drive module upon the child seat reaching a predetermined acceleration threshold. If acceleration limits are reached, the drive module is triggered, an energy charge is released, and the harness belt is tightened via a rotary or linear tensioning mechanism. The load limitation system limits the amount of tension applied to the harness belt.

### PRIORITY CLAIM AND CROSS-REFERENCE TO RELATED APPLICATIONS

The present application claims priority to and the benefit of U.S. Provisional Ser. No. 63/721,832 filed Nov. 18, 2024, which is incorporated herein by reference in its entirety and relied upon.

### BACKGROUND

Child restraint systems, also commonly called child safety seats, child seats, car seats, or booster seats, among others, are designed to protect children in vehicles from the effects of impacts or sudden changes in motion (e.g., sudden acceleration, sudden deceleration, and the like). Child restraint systems, referred to hereinafter as child seats, may be used in a variety of vehicles with different seat types and/or seating configurations. It is important for the child to be properly secured to the child seat to protect the occupant. Smaller children, such as babies or toddlers, are held firmly in their child seat mounted on a passenger seat of a vehicle with a special child restraint system, such as an integral harness system. For this age group, a safety seat with a 3-point or 5-point harness using a harness buckle as a coupling device is the safest way to travel. The 3-point or 5-point harness of the child seat firmly secures the child's shoulders and hips in the seat. It is important for the child to be protected from injury during collisions or in other situations involving high acceleration/deceleration, but it is not uncommon for a child seat's seat belt or harness to have insufficient tension. In such situations, an improper amount of integral harness belt tension is undesirable as it may negatively affect the safety of the occupant within the child seat.

In certain vehicles, seat belts are equipped with pre-tension modules. Shortly before an impending crash or other high acceleration/deceleration, the pre-tensioner substantially increases the overall tension of the seat belt, to facilitate early coupling of the occupant to the vehicle frame undergoing sudden acceleration/deceleration. A pre-tensioner is usually triggered by a controller, such as an engine control unit (ECU), that receives signals from sensors in the body of the vehicle, and it may be configured to operate once in a crash situation by using explosive expanding gas to drive a piston that retracts the belt. Alternatively, a pre-tensioner may use an electric drive, or more generally, an energy converter with a mechanical output that can operate repeatedly and for a sustained period to provide protection in non-collision events.

There may be cases when a pre-tensioner may not effectively reduce a person's degree of freedom. A pre-tensioner installed in a vehicle acts only on the respective seat belt where the pre-tensioner is installed. However, many child safety seat models comprise a dedicated child restraint system, such as an integral harness belt. In this case, the seat belts of a vehicle may be used only as a fixture for the child safety seat. If a pre-tensioner is triggered to increase the belt tension of a vehicle seat belt securing a child safety seat, the dedicated seat belts of the child safety seat remain unaffected by this action. Hence, the pre-tensioning action may result in the tighter fixture of the child safety seat to the vehicle itself, while the child's risk of inertial movement within any slack or clearance of the seat belt remains.

Accordingly, there is a need for an integral harness belt tensioning mechanism specifically configured for a child seat.

### SUMMARY

The present disclosure relates to child restraint systems and, more particularly, to a child safety seat. The child safety seat comprises an integral harness belt for restraining a child in the child safety seat and a motorized harness belt tensioner. The motorized harness belt tensioner comprises a tensioning element driven by an electromechanical actuator and adapted for adjusting the belt tension acting on the harness belt. Aspects of the subject matter described herein may be useful alone or in combination with one or more other aspects described herein. In an exemplary aspect of the present disclosure, a child seat is configured to be secured to a car seat. The child seat comprises an integral harness belt for restraining a child in the child seat. In the load path of the integral harness there is a belt tensioner and a belt force load limiter. The belt tensioner and load limiter can be used in combination together or independently of each other. The belt tensioner is activated by an electronic unit. Further, acceleration sensors measure the prevailing acceleration on the child seat. If acceleration limits are reached, the electronics are triggered, an energy charge is released, and the harness is tightened via a tightening mechanism. A load limiter ensures that certain belt load limits are not exceeded.

In alternative embodiments, the belt tensioner may be activated by mechanical means.

Many child safety seat models comprise a dedicated child restraint system, such as an integral harness belt. Embodiments may have the beneficial effect of minimizing the risk of inertial movement of a child seated in the child safety seat within any slack in or clearance of the integral harness belt in the case of sudden acceleration or deceleration through a suitable tightening of the integral harness belt. Because of the automatic adjusting of the belt tension by the motorized harness belt tensioner, no additional tightening of the harness belt may be required.

It has to be noted that generally the vehicle may be any vehicle that may carry the child safety seat, including cars, trucks, boats, trains, or airplanes. It is assumed that the vehicle can be assigned a forward direction x (roll axis), a lateral direction y (pitch axis) and a vertical direction z (yaw axis). The negative forward direction is referred to herein as the backward or reverse direction.

Likewise, the child safety seat is not restricted to any particular design. For instance, the child safety seat may be adapted for receiving a child in a sitting position, in a lying position (as may be the case with infant carriers or baby carriers) or in a transitional (tilted) position between sitting and lying. The child safety seat is also not restricted to fit the vehicle in any particular orientation, as may be the case with seats adapted for installation in the vehicle such that an occupant of the seat faces the forward or backward direction of the vehicle. Further, child safety seats that can be turned around a pivot point in between an entry position and a functioning position may be used. In the entry position, the seat may be oriented laterally so that an adult may easily position the child in the seat and then turn the seat toward the functioning position in which the child faces in the forward or backward direction of the vehicle.

The child safety seat may be placed on and/or attached to a seat of the vehicle comprising anchorage points to which the child safety seat can be connected. For example, the child safety seat may comprise locking mechanisms that make use of or are based on the conventional ISOFIX locking mechanism (or ISOFIX attachments). ISOFIX attachments are adapted to engage with corresponding anchorage points that are arranged in a line behind the area of the inflection point in which the seat surface of the vehicle seat borders on the seat backrest of the vehicle seat on which the child safety seat is to be installed.

In light of the disclosure herein, and without limiting the scope of the invention in any way, in a first aspect of the present disclosure, which may be combined with any other aspect listed herein unless specified otherwise, which may be combined with any other aspect listed herein unless specified otherwise, a system for child safety seat harness belt tensioning including a child safety seat, a child safety seat harness strap, and a harness belt tensioning assembly, where the child safety seat harness strap is fixedly coupled to the child safety seat, where the harness belt tensioning assembly is fixedly coupled to the child safety seat, where the child safety seat harness strap is coupled to the harness belt tensioning assembly, where the harness belt tensioning assembly is configured to automatically adjust a length of the child safety seat harness strap in response to a predetermined changed in acceleration, and where the harness belt tensioning assembly has a standard configuration, a belt tensioning configuration, and a force limiting configuration.

In a second aspect of the present disclosure, where the harness belt tensioning assembly comprises a base with side walls, an adjuster, an adjuster carriage, a connecting portion, a guide body, a force limiter, and a rolling element, where the base has a first end, a middle point, and a second end, where the adjuster carriage is located near the first end, and where the guide body is located near the second end.

In a third aspect of the present disclosure, which may be combined with any other aspect listed herein unless specified otherwise, where each side wall includes a force limiter track between the first end and the middle point, where each side wall includes a rolling element tooth track between the middle point and the second end, and where the force limiter track and the rolling element tooth track are on separate vertical planes.

In a fourth aspect of the present disclosure, which may be combined with any other aspect listed herein unless specified otherwise, where the adjuster is coupled to a top portion of the adjuster carriage, where the force limiter is coupled to a bottom portion of the adjuster carriage, where the force limiter engages with the force limiter track, such that the force limiter slides from the first end to the middle point, where the adjuster carriage and the adjuster slide when the adjuster slides, and where the child safety seat harness strap is coupled to the harness belt tensioning assembly through the adjuster, such that the child safety seat harness strap passes from the second end towards the first end via a slit on the adjuster and then loops back towards the second end so as to increase tension on the child safety seat harness strap.

In a fifth aspect of the present disclosure, which may be combined with any other aspect listed herein unless specified otherwise, where the rolling portion is coupled to a top portion of the guide body, where teeth on the rolling portion engage with the rolling element tooth track, such that the rolling portion translates from the second end to the middle point, and where guide body translates when the rolling portion translates.

In a sixth aspect of the present disclosure, which may be combined with any other aspect listed herein unless specified otherwise, where the guide body comprises a drive module, where the drive module comprises a pyrotechnic module configured to move the drive module towards the middle point, and where the pyrotechnic module is activated when sensors detect a threshold level of vehicle acceleration.

In a seventh aspect of the present disclosure, which may be combined with any other aspect listed herein unless specified otherwise, where in the standard configuration the adjuster carriage is in a position closest to the first end and furthest from the middle point, and where the guide body is in a position closest to the second end and furthest from the middle point.

In an eighth aspect of the present disclosure, which may be combined with any other aspect listed herein unless specified otherwise, where in the belt tensioning configuration the pyrotechnic module is activated when sensors detect a threshold level of vehicle acceleration to move the drive module towards the middle point, where a plurality of tooth elements on the underside of the drive module couple with the connecting portion so as to prevent the guide body from moving back towards the second end, where the drive module concurrently selectively couples with the adjuster carriage, and where the child safety seat harness strap unwinds from the second end towards the first end a first time.

In a ninth aspect of the present disclosure, which may be combined with any other aspect listed herein unless specified otherwise, where in the force limiting configuration the child safety seat harness strap pulls the adjuster carriage and force limiter towards the middle point, where concurrently the child safety seat harness strap unwinds from the second end towards the first end a second time, and where the child safety seat harness strap increases in tension.

In a tenth aspect of the present disclosure, which may be combined with any other aspect listed herein unless specified otherwise, a harness belt tensioning assembly, the harness belt tensioning assembly including a base with side walls, an adjuster, an adjuster carriage, a connecting portion, a guide body, a force limiter, and a rolling element, where the base has a first end, a middle point, and a second end, where the adjuster carriage is located near the first end, and where the guide body is located near the second end.

In an eleventh aspect of the present disclosure, which may be combined with any other aspect listed herein unless specified otherwise, where a child safety seat harness strap is fixedly coupled to a child safety seat, where the harness belt tensioning assembly is fixedly coupled to the child safety seat, where a child safety seat harness strap is coupled to the harness belt tensioning assembly, and where the harness belt tensioning assembly is configured to automatically adjust a length of the child safety seat harness strap in response to a predetermined changed in acceleration, and where the harness belt tensioning assembly has a standard configuration, a belt tensioning configuration, and a force limiting configuration.

In a twelfth aspect of the present disclosure, which may be combined with any other aspect listed herein unless specified otherwise, where each side wall includes a force limiter track between the first end and the middle point, where the each side wall includes a rolling element tooth track between the middle point and the second end, and where the force limiter track and the rolling element tooth track are on separate vertical planes.

In a thirteenth aspect of the present disclosure, which may be combined with any other aspect listed herein unless specified otherwise, where the adjuster is coupled to a top portion of the adjuster carriage, where the force limiter is coupled to a bottom portion of the adjuster carriage, where the force limiter engages with the force limiter track, such that the force limiter slides from the first end to the middle point, where adjuster carriage and adjuster slide when the adjuster slides, and where the child safety seat harness strap is coupled to the harness belt tensioning assembly through the adjuster, such that the child safety seat harness strap passes from the second end towards the first end via a slit on the adjuster and then loops back towards the second end so as to increase the tension on the child safety seat harness strap.

In a fourteenth aspect of the present disclosure, which may be combined with any other aspect listed herein unless specified otherwise, where the rolling portion is coupled to a top portion of the guide body, where teeth on the rolling portion engage with the rolling element tooth track, such that the rolling portion translates from the second end to the middle point, and where guide body translates when the rolling portion translates.

In a fifteenth aspect of the present disclosure, which may be combined with any other aspect listed herein unless specified otherwise, where the guide body comprises a drive module, where the drive module comprises a pyrotechnic module configured to move the drive module towards the middle point, and where the pyrotechnic module is activated when sensors detect a threshold level of vehicle acceleration.

In a sixteenth aspect of the present disclosure, which may be combined with any other aspect listed herein unless specified otherwise, where in the standard configuration the adjuster carriage is in a position closest to the first end and furthest from the middle point, and where the guide body is in a position closest to the second end and furthest from the middle point.

In a seventeenth aspect of the present disclosure, which may be combined with any other aspect listed herein unless specified otherwise, where in the belt tensioning configuration the pyrotechnic module is activated when sensors detect a threshold level of vehicle acceleration to move the drive module towards the middle point, where a plurality of tooth elements on the underside of the drive module couple with the connecting portion so as to prevent the guide body from moving back towards the second end, where the drive module concurrently selectively couples with the adjuster carriage, and where the child safety seat harness strap unwinds from the second end towards the first end a first time.

In an eighteenth aspect of the present disclosure, which may be combined with any other aspect listed herein unless specified otherwise, where in the force limiting configuration the child safety seat harness strap pulls the adjuster carriage and force limiter towards the middle point, where concurrently the child safety seat harness strap unwinds from the second end towards the first end a second time, and where the child safety seat harness strap increases in tension.

In a nineteenth aspect of the present disclosure, which may be combined with any other aspect listed herein unless specified otherwise, a method of using a harness belt tensioning assembly on a child safety seat, the harness belt tensioning assembly including a base with side walls, an adjuster, an adjuster carriage, a connecting portion, a guide body, a force limiter, and a rolling element, where the base has a first end, a middle point, and a second end, where the adjuster carriage is located near the first end, where the guide body is located near the second end, where a child safety seat harness strap is fixedly coupled to a child safety seat, where the harness belt tensioning assembly is fixedly coupled to the child safety seat, and where a child safety seat harness strap is coupled to the harness belt tensioning assembly, the method including detecting acceleration, determining acceleration meets or exceeds a predetermined threshold, activating a pyrotechnic module on the guide body, moving the guide body from the second end to the middle point towards the adjuster carriage, connecting the guide body with the adjuster carriage, and unwinding the child safety seat harness strap a first time.

In a twentieth aspect of the present disclosure, which may be combined with any other aspect listed herein unless specified otherwise, further including the child safety seat harness strap pulling the adjuster carriage and force limiter towards the middle point, and concurrently unwinding the child safety seat harness strap unwinds from the second end towards the first end a second time, where the child safety seat harness strap increases in tension.

In a twenty-first aspect of the present disclosure, any of the structure, functionality, and alternatives disclosed in connection with any one or more of FIGS. 1 to 25D may be combined with any other structure, functionality, and alternatives disclosed in connection with any other one or more of FIGS. 1 to 25D.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE FIGURES

The specification makes reference to the following appended figures, in which use of like reference numerals in different figures is intended to illustrate like or analogous components.

FIG. 1 illustrates an example of an exploded view of the harness belt tensioning mechanism with rotary movement, according to an example embodiment of the present disclosure;

FIG. 2 illustrates an example of a perspective view of the harness belt tensioning mechanism with rotary movement in a standard position, according to an example embodiment of the present disclosure;

FIG. 3 illustrates an example of perspective views of the harness belt tensioning mechanism with rotary movement in a belt tensioning position, according to an example embodiment of the present disclosure;

FIGS. 4A to 4B illustrate an example of a perspective view of the harness belt tensioning mechanism with rotary movement in a force limiting position, according to an example embodiment of the present disclosure;

FIG. 5 is a schematic drawing of a cross section of the ratchet assembly of the harness belt tensioning mechanism with rotary movement, according to an example embodiment of the present disclosure;

FIGS. 6A to 6D are schematic drawings of various views of the harness belt tensioning mechanism with rotary movement, according to an example embodiment of the present disclosure;

FIG. 7 illustrates an example of an exploded view of an alternative harness belt tensioning mechanism with rotary movement, according to an example embodiment of the present disclosure;

FIG. 8 illustrates an example of a perspective view of an alternative harness belt tensioning mechanism with rotary movement in a standard position, according to an example embodiment of the present disclosure;

FIG. 9 illustrates an example of a perspective view of the alternative harness belt tensioning mechanism with rotary movement in a belt tensioning position, according to an example embodiment of the present disclosure;

FIG. 10 illustrates an example of a perspective view of the alternative harness belt tensioning mechanism with rotary movement in a force limiting position, according to an example embodiment of the present disclosure;

FIG. 11 illustrates a cross-sectional top view of a ratchet assembly of the alternative harness belt tensioning mechanism with rotary movement, according to an example embodiment of the present disclosure;

FIGS. 12A to 12D are schematic drawings of various views of the alternative harness belt tensioning mechanism with rotary movement, according to an example embodiment of the present disclosure;

FIG. 13 is an example of an exploded view of a harness belt tensioning mechanism with linear movement, according to an example embodiment of the present disclosure;

FIG. 14 illustrates an example of a perspective view of the harness belt tensioning mechanism with linear movement in a standard position, according to an example embodiment of the present disclosure;

FIG. 15 illustrates an example of a perspective view of the harness belt tensioning mechanism with linear movement in a belt tensioning position, according to an example embodiment of the present disclosure;

FIGS. 16A to 16B illustrate examples of perspective views of the harness belt tensioning mechanism with linear movement in a force limiting position, according to an example embodiment of the present disclosure;

FIG. 17 illustrates a cross sectional top view of a ratchet assembly of the alternative harness belt tensioning mechanism with linear movement, according to an example embodiment of the present disclosure;

FIGS. 18A to 18D are schematic drawings of various views of the harness belt tensioning mechanism with linear movement, according to an example embodiment of the present disclosure;

FIG. 19 illustrates an example of a perspective view of an alternative harness belt tensioning mechanism with linear movement in a standard position, according to an example embodiment of the present disclosure;

FIG. 20 illustrates an example of a perspective view of an alternative harness belt tensioning mechanism with linear movement in a belt tensioning position, according to an example embodiment of the present disclosure;

FIG. 21 illustrates an example of a perspective view of an alternative harness belt tensioning mechanism with linear movement in a force limiting position, according to an example embodiment of the present disclosure;

FIG. 22 illustrates an example of a perspective view of a brake system assembly of the harness belt tensioning mechanism, according to an example embodiment of the present disclosure;

FIGS. 23A to 23C illustrate an example of a perspective view of a brake system assembly of the harness belt tensioning mechanism in a first position, a second position, and a third position, according to an example embodiment of the present disclosure;

FIG. 24 illustrates a partial view of the harness belt tensioning mechanism 400 and its various components, according to an example embodiment of the present disclosure; and

FIGS. 25A to 25D are schematic drawings of various views of the alternative harness belt tensioning mechanism with linear movement, according to an example embodiment of the present disclosure.

### DETAILED DESCRIPTION

Systems, methods, and apparatus are disclosed herein for an integral harness belt tensioning mechanism for a child seat. Example embodiments will now be described more fully with reference to the accompanying drawings

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or additional of one or more other features, integers, steps, operations, elements, components, and/or groups thereof.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent”). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

A child seat may be configured for installation based on the height and weight of a child and according to various guidelines and standards, such as those of the United States National Highway Transportation Safety Administration. To ensure maximum protection for an occupant of the child seat, the child seat must be secured to a fixed location in a vehicle, such as using a seat belt of the car seat or Lower Anchors and Tethers for Children (“LATCH”) attachments. When seat belts are used to secure the child seats, the seat belts are often positioned around the child seat and then engaged with a buckle attached to the car seat. The occupant of the child seat is then securely retained within the child seat via one or more child seat belts or harness belts. Undesirable slack in these child seat belts or harness belts may often occur, even when these components are tightly fastened. Such slack causes the occupant to be loosely secured to the child seat, which presents an unsafe condition for the occupant of the child seat. This undesirable slack is all the more dangerous during high acceleration/deceleration conditions, such as shortly before or during a vehicle crash.

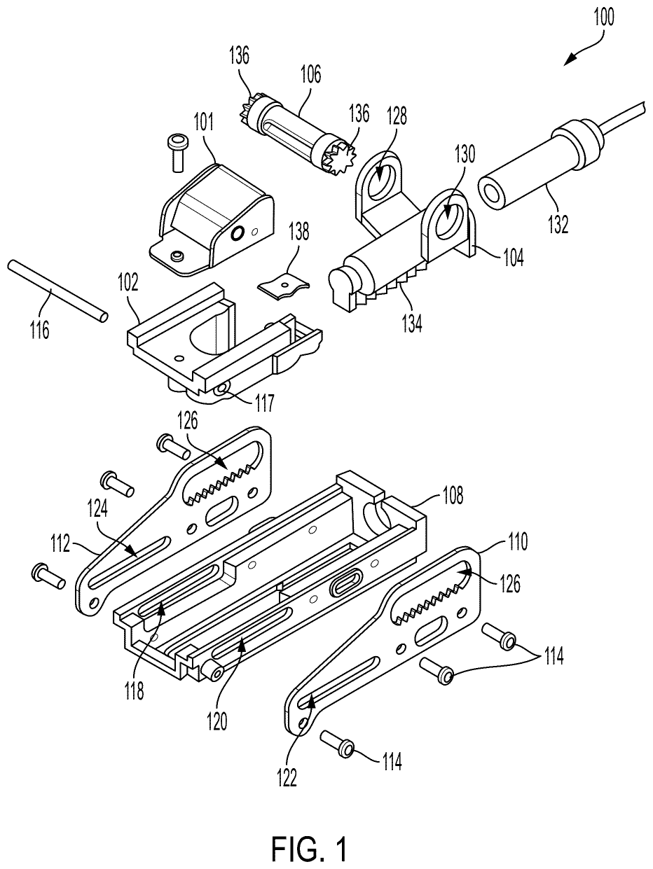

FIG. 1 illustrates an example of an exploded view of a harness belt tensioning mechanism with rotary movement (“harness belt tensioning mechanism”). The harness belt tensioning mechanism 100 includes an adjuster 101, an adjuster carriage 102, a guide body 104, and a rolling element 106, each of which are slidably coupled to a base 108 of the harness belt tensioning mechanism 100. Also included are two side walls 110, 112 permanently coupled to the base 108 via attachment elements 114, such as screws. Side walls 110, 112 may be oriented in a vertical direction relative to the base 108, such that side walls 110, 112 are orthogonal to the base 108. Additionally, the harness belt tensioning mechanism 100 includes a force limiter 116 configured to extend perpendicularly through the front end of the narrow bottom portion 117 of the adjuster carriage 102. The force limiter 116 may be in the shape of a cylindrical bar, or any other suitable configuration. The force limiter 116 may have a larger length than the width of the adjuster carriage 102 and of the base 108, such that the force limiter 116 extends through the base's 108 slotted holes 118, 120 and extends through the side walls'110, 112 slotted holes 122, 124. Further, each of the side walls 110, 112 includes an opening 126 with a plurality of toothed elements, such as a gear rack. Notably, in alternate embodiments, the opening 126 may include a smooth, or different, geometry. These alternative geometries are discussed in greater detail herein.

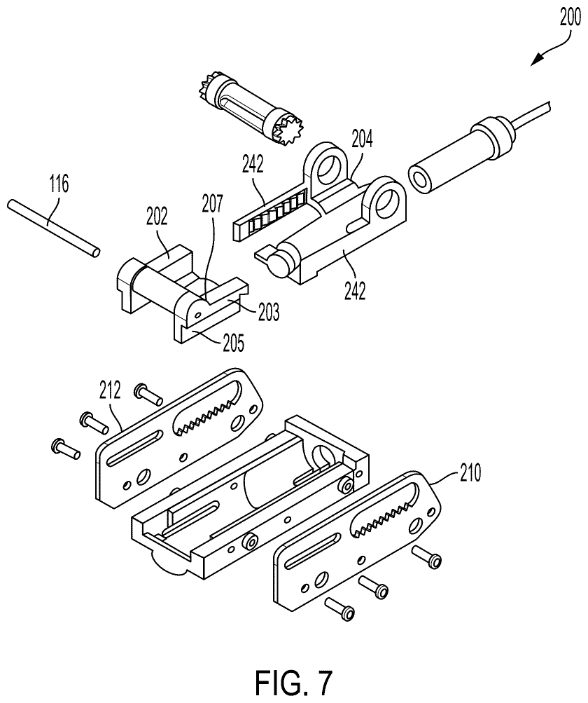

The rolling element 106, which may include a gear wheel 136 on each of its ends, is configured to extend perpendicularly through two openings 128, 130 in the guide body 104. The guide body's 104 openings 128, 130 may be any suitable shape to accommodate the insertion of the rolling element's 106 ends. For example, openings 128, 130 may be circular. The openings 128, 130 may protrude vertically from the guide body 104. In an assembled configuration, the guide body 104 is engaged with a drive module 132. The guide body 104 also includes a plurality of toothed elements 134 on its underside. The plurality of toothed elements 134 may be part of a ratchet (as shown in FIG. 7) further comprising a connecting element 138, such as a pawl. It should be emphasized that the harness belt tensioning mechanism 100 is integral to a child seat (not shown).

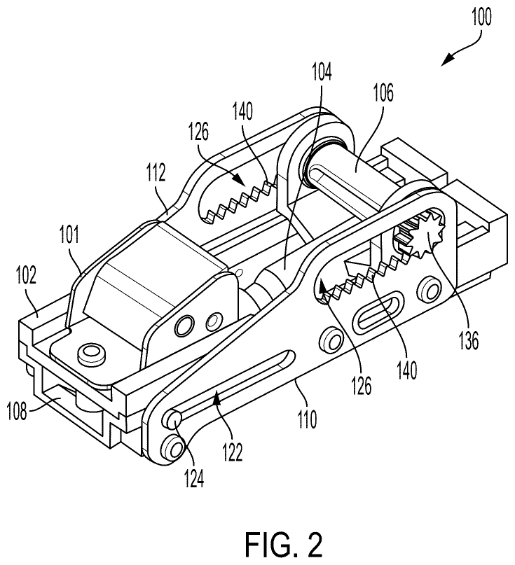

FIG. 2 illustrates a perspective view of the harness belt tensioning mechanism 100 in a standard position. The harness belt tensioning mechanism 100 includes the adjuster 101, adjuster carriage 102, a guide body 104, a rolling element 106 slidably coupled to the base 108, and two side walls 110, 112. In the standard position, as shown in FIG. 2, the adjuster carriage 102 is stored at the front end of the base 108, and the guide body 104 and rolling element 106 are stored at the opposite back end of the base 108. The width of the adjuster 101 is less than the width of the adjuster carriage 102 such that the adjuster 101 can sit on top of the adjuster carriage 102 between two raised edges of the adjuster carriage 102. Further, the adjuster carriage 102 is not directly engaged with the guide body 104.

The adjuster carriage 102, the guide body 104, and the rolling element 106 are located between two side walls 110, 112 that are permanently coupled to the base 108. The side walls 110, 112 have a tapered shape, such that the narrow end of the side wall 110, 112 is located adjacent to the adjuster carriage 102 in the standard position, and the wide end of the side wall 110, 112 is located adjacent to the guide body 104 and rolling element 106 in the standard position. As shown in FIG. 1, the adjuster carriage 102 includes a narrow bottom portion 117 that further includes two holes configured to house the force limiter 116. Now, continuing with FIG. 2, the force limiter 116 extends perpendicularly through the adjuster carriage 102 and extends perpendicular to the side walls 110, 112.

In certain embodiments, the force limiter 116 may be longer in length than the width of the adjuster carriage 102 and base 108 such that both ends of the force limiter 116 extend through slotted holes 118, 120 in the base 108 and slotted holes 122, 124 at the narrow end of the side walls 110, 112. The force limiter 116 is configured to translate horizontally through the base's 108 slotted holes 118, 120 at the same time it translates horizontally through the side walls'110, 112 slotted holes 122, 124.

The wide end of each of the side wall's 110, 112 include an opening 126 with a gear rack 140 comprising a plurality of toothed elements. Each end of the rolling element 106 may include a gear wheel 136 that engages with the gear rack 140. Moreover, a harness strap (not shown) is placed through the adjuster 101, such that the harness strap is guided from the end of the harness belt tensioning mechanism 100 near the opening 126 with the gear track, to the end with the slotted holes 122, 124. The harness strap slips through the adjuster 101, such that the harness strap passes from near the opening 126 with the gear track, to the end with the slotted holes via a slit on the adjuster 101 and then loops back towards the opening 126 with the gear track so as to increase tension on the child safety seat harness strap.

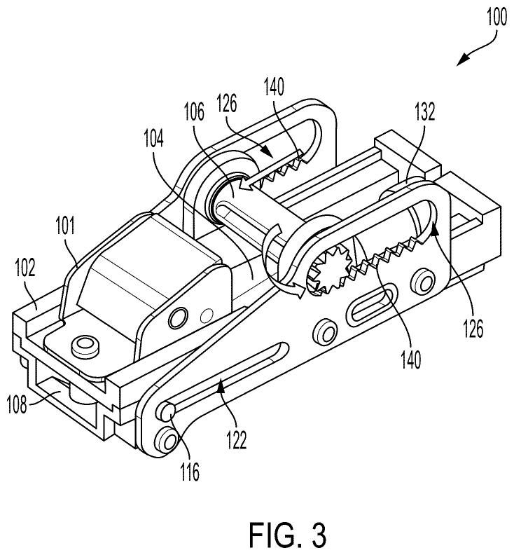

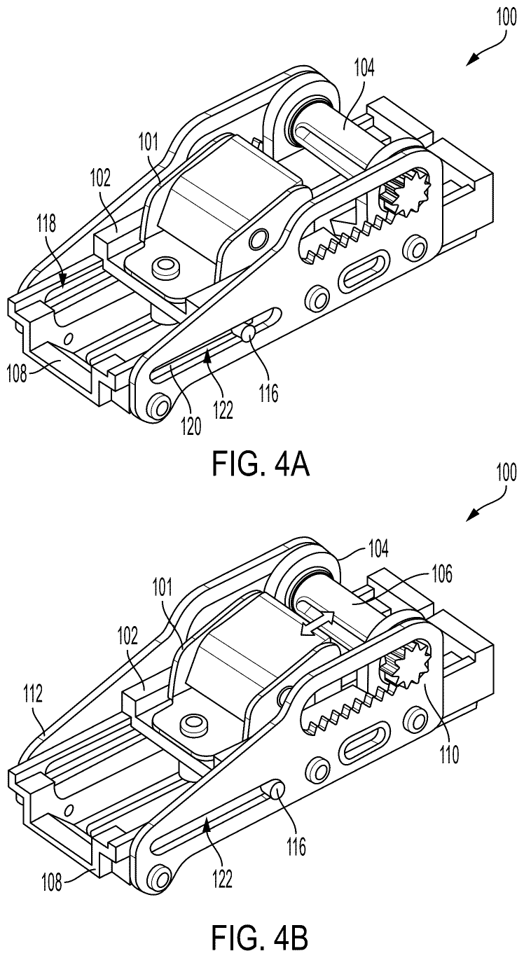

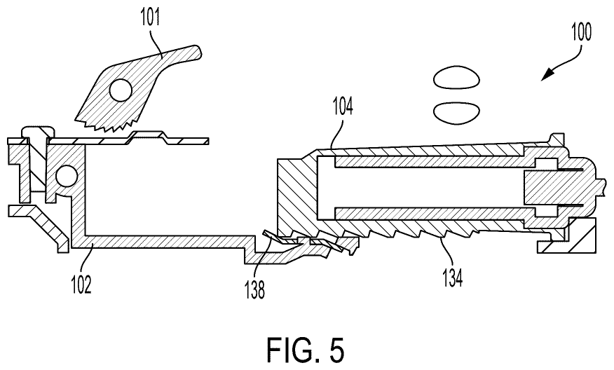

FIG. 3 illustrates a perspective view of the harness belt tensioning mechanism 100, described in greater detail with respect to FIG. 4, in a first belt tensioning position. The harness belt tensioning mechanism 100 includes a drive module 132 that is activated, or triggered, when the acceleration of the vehicle carrying the child safety seat (not shown) utilizing the harness belt tensioning mechanism 100 reaches a predefined threshold as determined by a control unit and related sensor(s), which could include, but are not limited to, accelerometers disposed on the child seat or accelerometers disposed on the vehicle. In an embodiment where accelerometers are disposed on the vehicle, a control unit of the harness belt tensioning mechanism 100 would be in wireless communication with said accelerometers and other related control systems of the vehicle. In an embodiment where accelerometers are disposed on the child safety seat, the entire acceleration/deceleration identification system could be self-contained on the child safety seat. In either instance, the drive module 132 is configured for acceleration-dependent triggering. When the drive module 132 is triggered, it drives the guide body 104 towards the adjuster carriage 102. In an exemplary embodiment, the drive module 132 is a pyrotechnic module that explosively drives the guide body 104 forward, which causes the rolling element 106 to rotate along the gear rack 140. In alternative embodiments, the drive module 132 employs other means for rapidly driving the guide body 104 forward, such as via an electric motor, via a solenoid, or via other electromagnetic means affording quick force-transfer. Additionally, upon activation of the drive module 132, when the guide body 104 is driven towards the adjuster carriage 102, the plurality of toothed elements 134 on the underside of the guide body 104 engage with the connecting element 138 (shown in FIGS. 1 and 5).

Once the guide body 104 is driven towards the adjuster carriage 102, approximately 30 mm, the guide body 104 locks immediately upon engaging with the adjuster carriage 102. The guide body locking mechanism can be a form fit lock or force fit lock. In the belt tensioning position, the adjuster carriage 102 and the force limiter 116 do not move. The adjuster carriage 102 and the force limiter 116 are in the same position as they are in the standard position. However, during the belt tensioning position, the belt harness strap (not shown) is unwound approximately 60 mm towards the end with the slotted holes 122, 124. Additionally, in the belt tensioning position, the plurality of toothed elements 134 on the guide body 104 engage with the connecting element 138. Thus, when a predefined threshold of acceleration is established and the drive module 132 advances the guide body 104, the plurality of toothed elements 134 glide over the connecting element 138 until the guide body 104 engages the adjuster carriage 102. The connecting element 138 facilitates continuous linear motion of the guide body 104 in the direction of the adjuster carriage 102 but does not permit reverse movement. Accordingly, the plurality of toothed elements 134 and the connecting element 138 comprise a ratchet. For example, when at least one of the toothed elements 134 passes the connecting element 138, the connecting element 138 engages with the toothed element 134 and blocks the guide body 104 from passing back over the connecting element 138. Therefore, the connecting element 138 couples the adjuster carriage 102 to the guide body 104. FIG. 7, discussed further below, illustrates in more detail the previously described mechanism of the connecting element 138 and the plurality of toothed elements 134 on the guide body 104. It should be appreciated that the drive distances discussed above, and further below, are exemplary and nature and not intended to be limiting. Shorter and longer drive distances are, likewise, contemplated herein.

FIGS. 4A and 4B illustrate perspective views of a force limitation mechanism of the harness belt tensioning mechanism 100. As shown in FIG. 4A, when the vehicle carrying the child safety seat reaches a predetermined acceleration/deceleration threshold, the harness strap (not shown) pulls the adjuster carriage 102 and guide body 104 approximately 30 mm. During this time, the harness strap unwinds for a second time approximately 60 mm towards the end with the slotted holes 122, 124. The force limiter 116 translates through the base's 108 slotted holes 118, 120 at the same time it translates horizontally along the side wall's 110, 112 slotted holes 122, 124 (slotted hole 124 not shown in FIG. 4A or 4B), but does not reach the opposite end of either the base's 108 slotted holes or the side wall's 110, 112 slotted holes 122. In particular, the force limiter 116 stops approximately 10 mm short of reaching the opposite end of the slotted holes 122, 124. The guide body 104 and the rolling element 106 remain in their original standard position in relation to the side walls 110, 112. It should be appreciated that, in alternative embodiments, adjuster carriage 102 and guide body 104 are pulled a different length, such as 15 mm. Namely, any increase in overall harness strap tension is an improvement over pre-existing conditions where harness strap slack exists.

As shown in FIG. 4B, the adjuster carriage 102 may translate an additional 10 mm, approximately, to reach the end of the slide wall's 110, 112 slotted holes 122, 124. This additional translation of approximately 10 mm accommodates for overflow of the harness strap. For example, when the adjuster carriage 102 translates the additional approximately 10 mm, the harness strap tightens an additional 40 mm, approximately. The adjuster 101, adjuster carriage 102, and force limiter 116 are the only components of the harness belt tensioner mechanism that move to accommodate overflow of the harness strap.

FIG. 5 is a schematic drawing of a cross section of a ratchet assembly of the harness belt tensioning mechanism 100 described in FIGS. 3 to 6B. In particular, this schematic illustrates the underside of the guide body 104 including the plurality of toothed elements 134 that may engage with the connecting element 138 that is coupled to the adjuster carriage 102. The connecting element 138 may be, for example, a pawl.

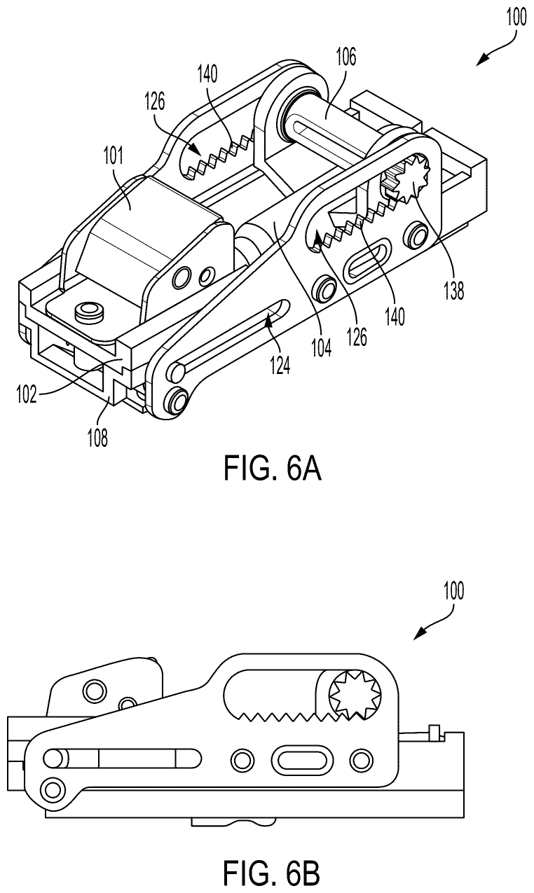

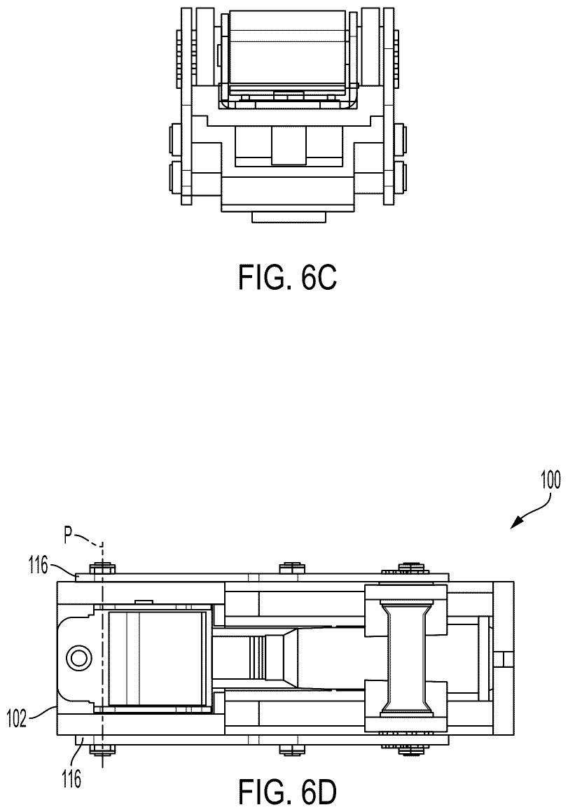

FIGS. 6A to 6D illustrate schematic drawings of the harness belt tensioning mechanism described in reference to FIGS. 1 to 5. FIG. 6A is a schematic drawing of the harness belt tensioning mechanism 100 in a standard position. FIGS. 6B to 6C are schematic drawings of a side view and a rear view of a harness belt tensioner mechanism 100, respectively. The harness belt tensioner mechanism may be any suitable length, height, and width to accommodate a harness belt or strap for a child safety seat. For example, the harness belt tensioner mechanism may be 131 mm in length, 47 mm in height, and 49 mm to 55 mm in width. FIG. 6D is a top view of the harness belt tensioner mechanism 100 illustrating the force limiter 116 extending perpendicularly (P) through adjuster carriage 102 and the base 108 (not shown).

FIG. 7 illustrates an example of an exploded view of an alternative harness belt tensioner mechanism with rotary movement. The harness belt tensioner mechanism 200 described in FIG. 7 may include similar physical components as the harness belt tensioner mechanism 100 described in reference to FIGS. 1 to 6D, and further includes certain modifications as described in more detail below. For example, the harness belt tensioner mechanism 200 includes an adjuster carriage 202 with an upper portion 203 and a lower portion 205, two side walls 210, 212 each having a substantially rectangular shape that has at least one end with a slightly tapered shape, and a guide body with a plurality of toothed elements disposed internally on lateral arms 242 extending from the guide body 204. The upper portion 203 includes a ramp-shaped portion 207 extending upwards and away from the lower portion 205 of the adjuster carriage 202. The ramp-shaped portion 207 includes two holes configured to accommodate a force limiter 116.

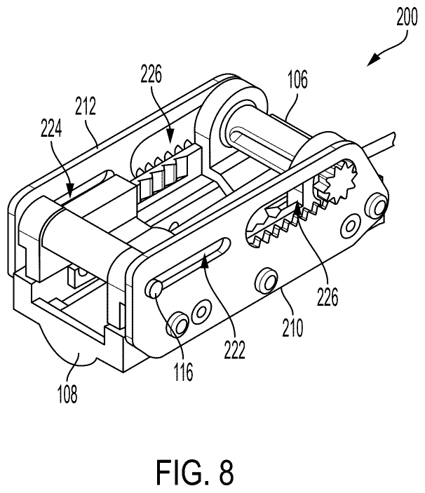

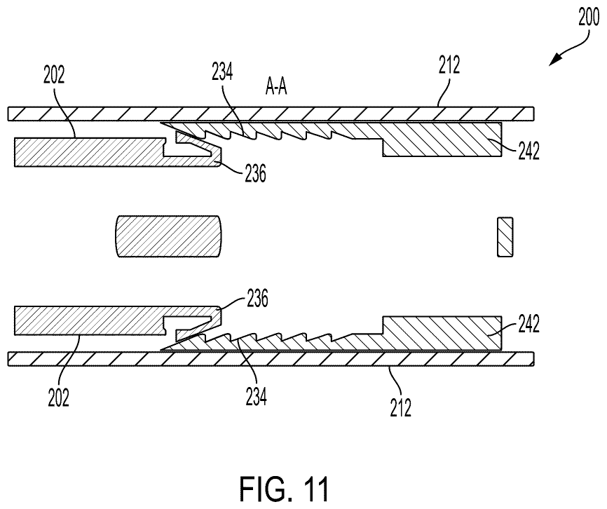

FIG. 8 illustrates an example of a perspective view of the harness belt tensioner mechanism with rotary movement described in FIG. 7 in a standard position. The harness belt tensioner mechanism 200 includes two side walls 210, 212. The side walls 210, 212 include slotted holes 222, 224 and openings 226 with a plurality of toothed elements 134. The force limiter 116 extends through the hollow tunnel of the adjuster carriage 202. Further, the force limiter 116 is configured to translate vertically along slotted holes 222, 224 in the side walls 210, 212. The slotted holes 222, 224 are located adjacent to, but not touching, the opening 226 in the side walls. For example, the slotted holes 222, 224 are located at the same height of the side walls 210, 212 as the opening 226. Both the slotted holes 222, 224 and the opening 226 are located at a distance higher than the base 108. The side walls 210, 212 are tapered such that the narrow end of the taper is adjacent to the rolling element 106 when in the standard position. Furthermore, the guide body 204 includes a plurality of toothed elements 234 on the internal side of at least one of its extending arms 242. These plurality of toothed elements 234 may form a ratchet (as shown in FIG. 11) further comprising at least one connecting element 236, such as a pawl, located on the adjuster carriage 202.

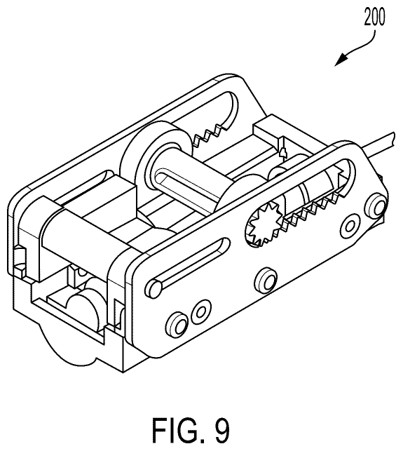

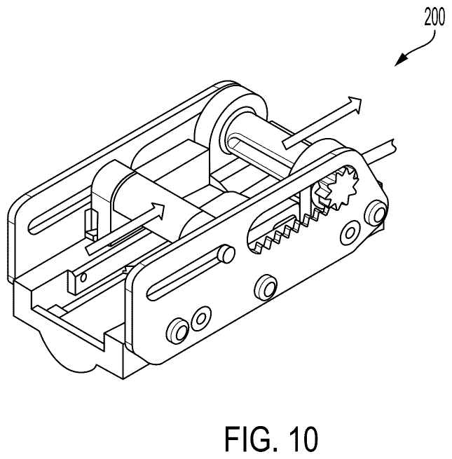

FIG. 9 illustrates an example of a perspective view of the harness belt tensioning mechanism 200 described in FIGS. 7 and 8 in a belt tensioning position. The harness belt tensioner mechanism 200 may include similar adjustment movements as the harness belt tensioner mechanism 100 described in reference to FIGS. 1 to 6B. Similarly, FIG. 10 illustrates a perspective view of the harness belt tensioning mechanism 100 described in FIGS. 7 to 9 after effective load limitation, such as after the force limiting position. The arrows indicate movement from the force limiting position to the post-load limitation position. The harness belt tensioner mechanism 200 may include similar adjustment movements as the harness belt tensioner mechanism 100 described in reference to FIGS. 1 to 6B.

FIG. 11 is a schematic drawing of a cross section (A-A) view of a ratchet assembly of the harness belt tensioning mechanism 200 described in FIGS. 7 to 10. In particular, this schematic illustrates the guide body's two arms 242 that have a plurality of toothed elements 234 that may engage with the connecting element 236 that is coupled to the adjuster carriage 202. During engagement, the guide body's arms 242 may move in an open space between the side walls 210, 212 and the adjuster carriage 202. The plurality of toothed elements 234 are located on the internal side of the guide body's arms 242. The connecting element 236 may be, for example, a pawl. Alternatively, the guide body's arms 242 may engage with the connecting element 236 via form fit elements or force fit elements.

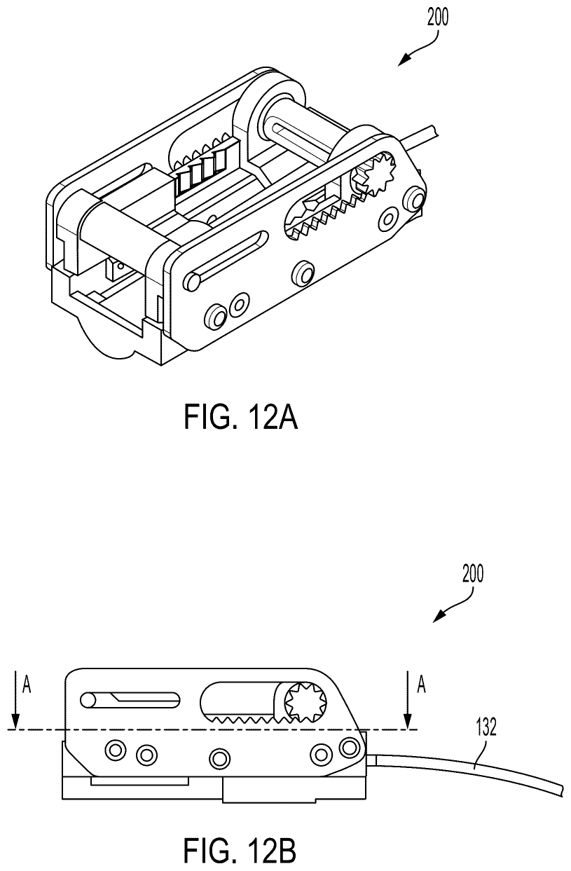

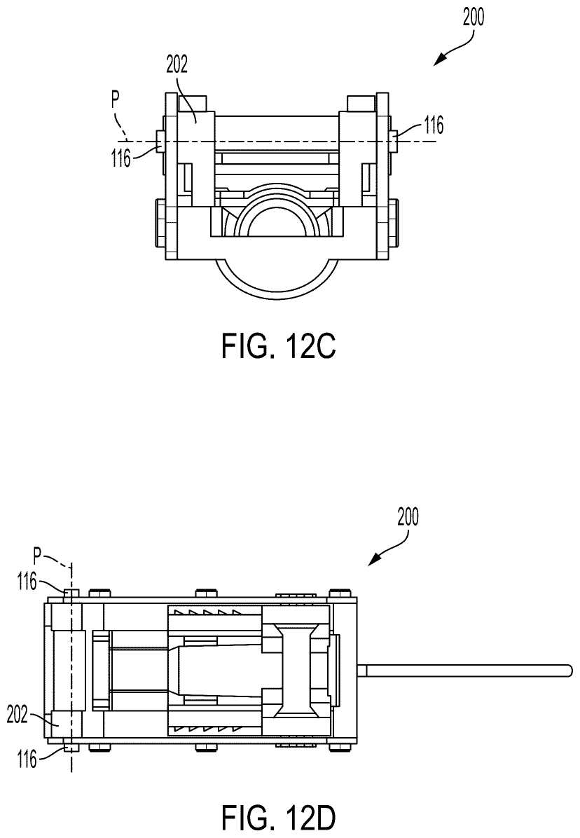

FIGS. 12A to 12D illustrate schematic drawings of the harness belt tensioning mechanism 200 described in reference to FIGS. 7 to 11. FIG. 12A is a schematic drawing of the harness belt tensioning mechanism 200 in a standard position. FIGS. 12B to 12C are schematic drawings of a side view and a rear view of a harness belt tensioner mechanism 200, respectively. The harness belt tensioner mechanism 200 may be any suitable length, height, and width to accommodate a harness belt or strap for a child safety seat. For example, the harness belt tensioner mechanism may be 108 mm in length (not including the length of the drive module 132), 47.8 mm in height, and 51 mm to 56.2 mm in width. FIG. 12D is a top view of the harness belt tensioner mechanism 200. FIGS. 12C and 12D illustrate the force limiter 116 extending perpendicularly (P) through adjuster carriage 202 and the base 108 (base 108 not shown in FIG. 12D).

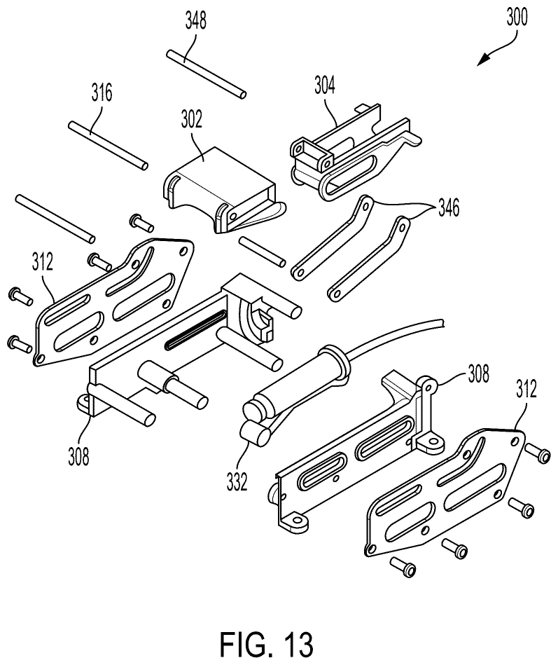

FIG. 13 illustrates an example of an exploded view of a harness belt tensioner mechanism 300 with linear movement. Each of the components of the harness belt tensioner mechanism 300 are configured similarly to the harness belt tensioners 100 and 200 described above in reference to FIGS. 1 to 12D, with certain modifications. These modifications include changes to the load tensioning mechanism from a rotary mechanism (described in FIGS. 1 to 12D) to a linear mechanism as described further below. Specifically, rather than the rotary load tensioning mechanism described in FIGS. 1 to 12D, the harness belt tensioner mechanism 300 of the present embodiment comprises a linear tensioner being part of linear movement with a load limiter. As shown in FIG. 13, the harness belt tensioner mechanism 300 is in a standard position. The harness belt tensioner mechanism 300 comprises an adjuster carriage 302, a base 308, two side walls 310, 312, a guide body 304, a force limiter 316, a drive module 332, and an actuator slide 346 with tension levers 348. It should be appreciated by one of ordinary skill in the art that certain embodiments described above, with respect to rotary mechanisms, are, likewise, applicable to the linear mechanism described below. Similarly, it should be appreciated by one of ordinary skill in the art that certain embodiments described below, with respect to linear mechanisms, are, likewise, applicable to the rotary mechanism described above

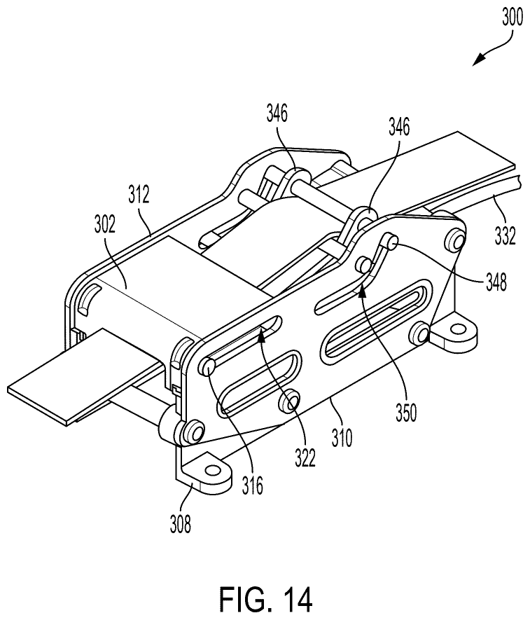

FIG. 14 illustrates an example of a perspective view of the harness belt tensioning mechanism 300 with linear movement in a standard position. In the standard position, as shown in FIG. 14, the adjuster carriage 302 is stored on top of the front end of the base 308, at the opposite end of the drive module 332. The adjuster carriage is coupled to the side walls 310, 312 by the force limiter 316, which extends horizontally through two holes in the adjuster carriage 302. The force limiter 316 extends perpendicularly through the adjuster carriage 302 and extends perpendicular to the side walls 310, 312, which are permanently coupled to the base 308. The force limiter 316 may be longer in length than the width of the adjuster carriage 302 such that both ends of the force limiter 316 extend through slotted holes 322, 324 of the side walls 310, 312. In the standard position, the force limiter 316 is stored in the end of the slotted holes 322, 324 furthest away from the drive module 332. The force limiter 316 is configured to translate horizontally through the slotted holes 322, 324. Slotted hole 324 is not shown in FIG. 14. The harness belt tensioner mechanism 300 also includes an actuator slide 346 with a tension lever 348. In the standard position, the actuator slide 346 with tension lever 348 is stored at the top of a ramp-shaped opening 350, similar to a slide in the side walls 310, 312.

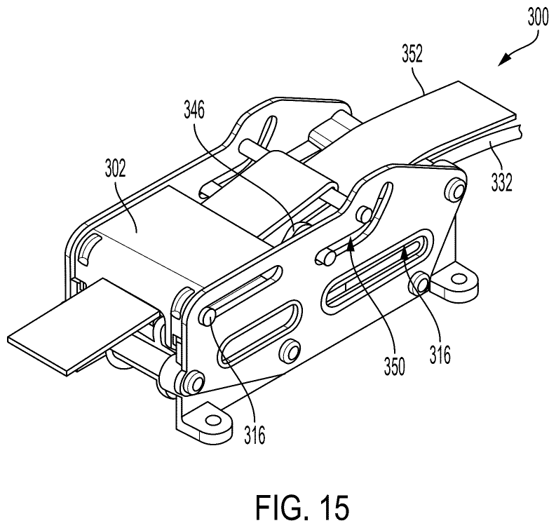

FIG. 15 illustrates an example of a perspective view of the harness belt tensioning mechanism with linear movement described in FIGS. 13 and 14 in a belt tensioning position. When the drive module 332 is triggered, or activated, upon recognizing a predetermined acceleration threshold, the harness belt tensioner mechanism 300 first moves from the standard position to the belt tensioning position. In the belt tensioning position, drive module 332 drives the actuator slide 346 with tension levers 348 in the direction of the adjuster carriage 302 and force limiter 316 approximately 30 mm. This movement causes the actuator slide 346 with tension levers 348 to slide to the bottom end of the ramp-shaped opening 350. Once the actuator slide 346 with tension levers 348 is at the bottom of the ramp-shaped opening 350, the guide body 304 engages with the force limiter 316 and adjuster carriage 302. When the harness belt tensioner mechanism moves from the standard position to the belt tensioning position, the belt 352 is wound up approximately 60 mm, providing approximately 60 mm of belt pull. However, the force limiter 316 and adjuster carriage 302 remain in the same position as they were during the standard position described above in reference to FIG. 14. It should be understood that simple design changes would vary the distance that the drive module 332 drives the actuator slide 346 towards the adjuster carriage 302 and force limiter 316. For example, the distance may be longer or shorter than the 30 mm distance described above in reference to FIG. 15.

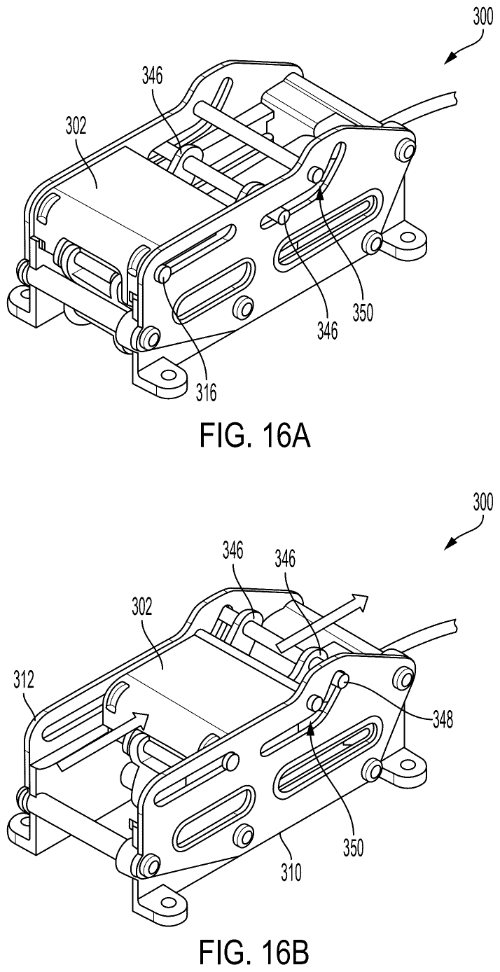

FIGS. 16A and 16B illustrate perspective views of the harness belt tensioning mechanism with linear movement in a force limiting position. After the belt tensioning position, the harness belt tensioner mechanism 300 is in the force limiting position. In the force limiting position, the tension lever 348 is connected to the force limiter 316 which is connected to the adjuster carriage 302. The belt (not shown) pulls backwards on the tension lever 348 and force limiter 316, which causes the tension lever 348 to be pulled in a reverse direction bringing along the adjuster carriage 302 and force limiter 316. For example, the adjuster carriage 302 and force limiter 316 are pulled backwards together approximately 30 mm. The force limiter 316 translates horizontally through the slotted holes 322, 324 in the side walls 310, 312. During this movement, the actuator slide 346 with the tension lever 348 moves vertically up the ramp-shaped opening 350 in the side walls 310, 312. Further, the harness belt is braked and the belt is unwound again for approximately 60 mm.

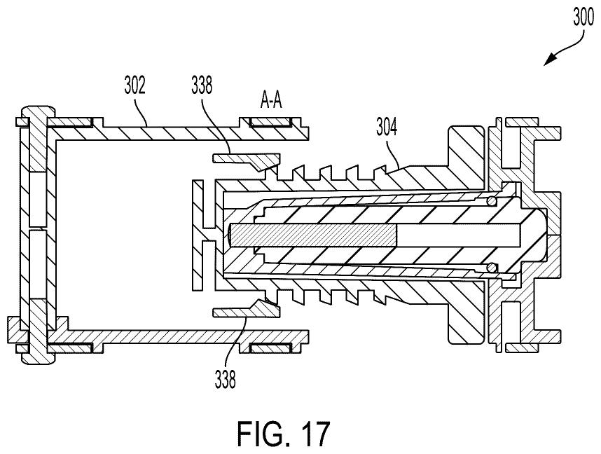

FIG. 17 illustrates a cross-section (A-A) top view of a ratchet assembly of the harness belt tensioning mechanism with linear movement described in FIGS. 13 to 17D. In particular, this schematic illustrates the guide body 304 engaging with at least one connecting element 338 on the adjuster carriage 302. The at least one connecting element 338 includes at least one raised protrusion, such as a tooth or pawl, for engaging with the plurality of toothed elements on the guide body 304.

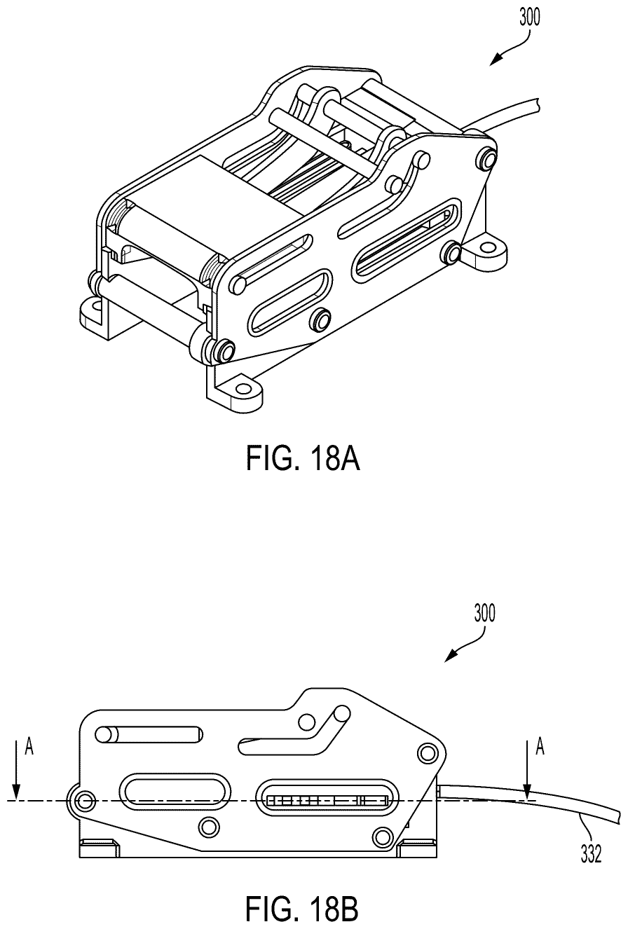

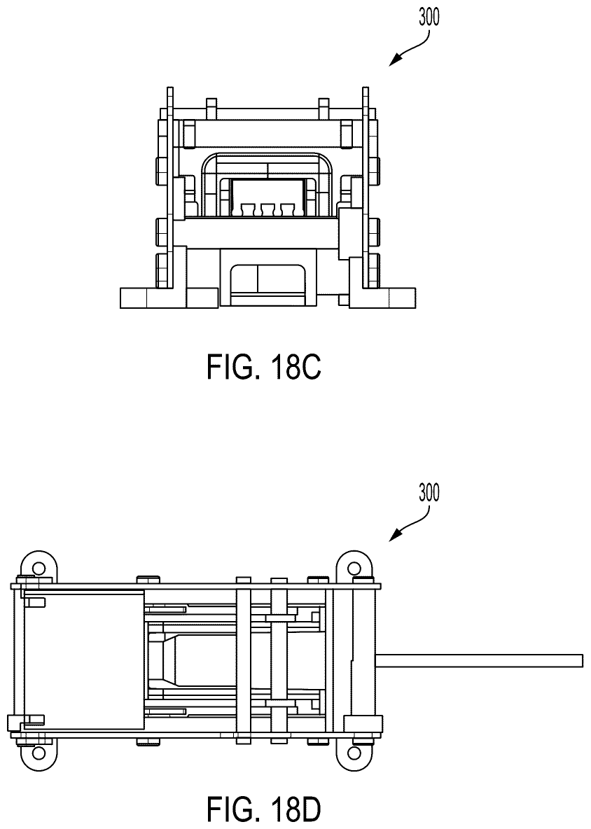

FIGS. 18A to 18D show schematic drawings of various views of the harness belt tensioning mechanism with linear movement described in FIGS. 13 to 16B. FIG. 18A is a schematic drawing of the harness belt tensioning mechanism 300 in a standard position. FIGS. 18B to 18C are schematic drawings of a side view and a rear view of a harness belt tensioner mechanism 300, respectively. The harness belt tensioner mechanism 300 may be any suitable length, height, and width to accommodate a harness belt or strap for a child safety seat. For example, the harness belt tensioner mechanism may be 121.5 mm in length (not including the length of the drive module 332), 56 mm in height, and 57.2 mm in width. FIG. 18D is a top view of the harness belt tensioner mechanism 300.

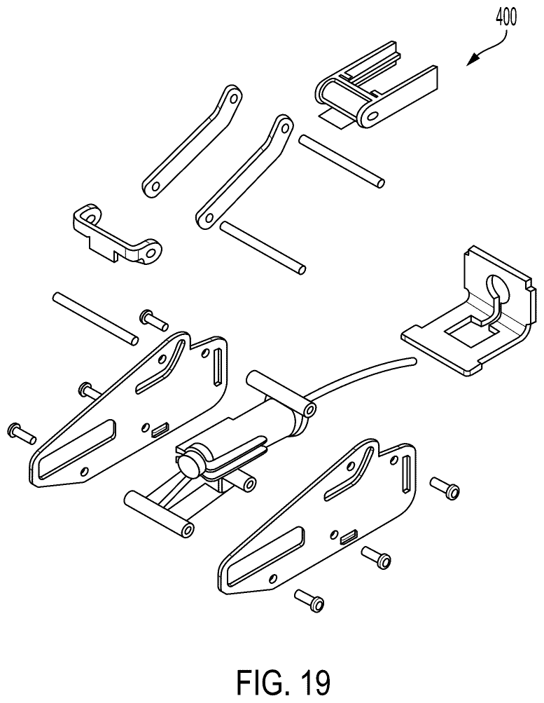

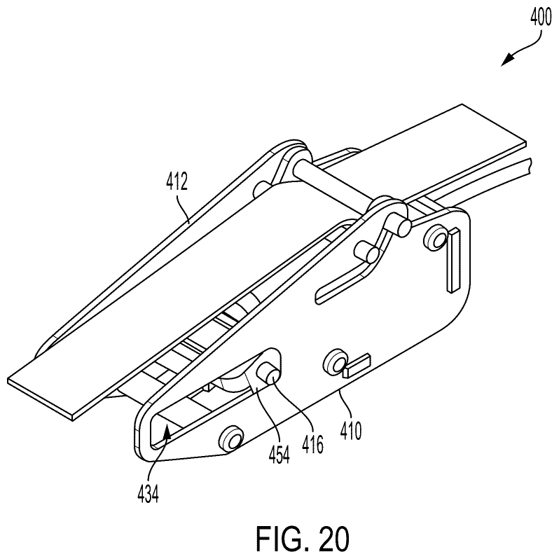

FIG. 19 illustrates an example of an exploded view of an alternative harness belt tensioning mechanism 400 with linear movement. The harness belt tensioner mechanism described in FIGS. 20 to 25D includes similar components as the harness belt tensioner mechanism 300 described in FIGS. 13 to 17, and has optional modifications that will be discussed further below. For example, as shown in FIG. 20, the harness belt tensioner mechanism 400 is in a standard position, and comprises a brake lever 454 that extends perpendicularly through slotted holes 434 in the side walls 410, 412. The brake lever may have a length that is the same as, or longer than the side walls 410, 412. The brake lever has is configured to house the force limiter 416. The force limiter 416 is larger in length than the brake lever 454 such that the force limiter 416 may extend beyond the outer edge of the side walls 410, 412.

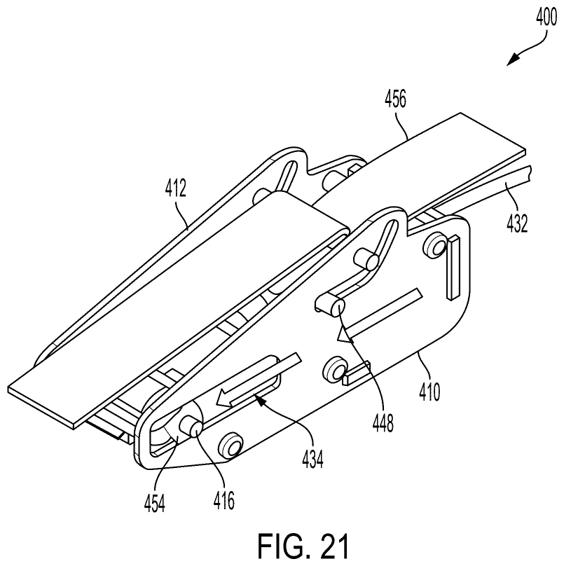

FIG. 21 illustrates an example of a perspective view of the alternative harness belt tensioning mechanism with linear movement described in FIGS. 19 and 20 in a belt tensioning position. When the harness belt tensioner mechanism 400 is in the belt tensioning position, the drive module 432 forces the guide body 404 to drive the actuator slide 446 with the tension levers 448 in the direction of the brake lever 454. During this movement, the guide body 404, acting as a pushing element, causes the brake lever 454 to translate horizontally along the slotted holes 434, 436 in the side walls 410, 412. During this movement, the harness belt 456 is wound up approximately 60 mm, providing approximately 60 mm of belt pull.

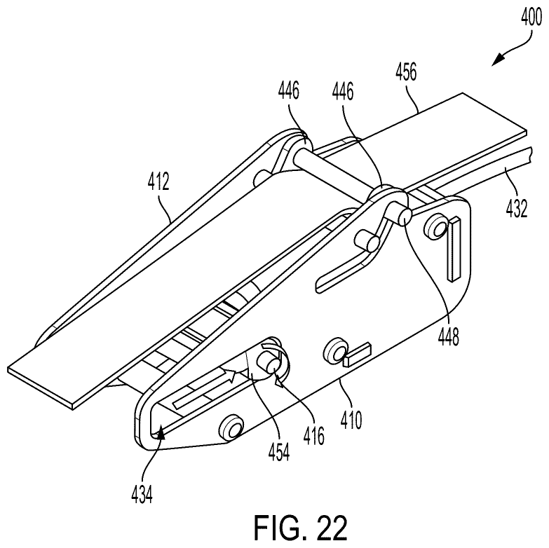

Once the harness belt 456 is wound up approximately 60 mm, the belt 456 pulls backwards on the tension lever 448 and brake lever 454, as shown in FIG. 22. Then, the actuator slide 446 and brake lever 454 are pulled backwards together, approximately 30 mm. When the brake lever 454 reaches the end of the slotted hole 434, 436 in the side walls 410, 412, the brake lever 454 is braked and the harness belt 456 is unwound again, approximately 60 mm. Jamming the brake lever 454 causes the harness belt tensioning mechanism to be in the force limiting position.

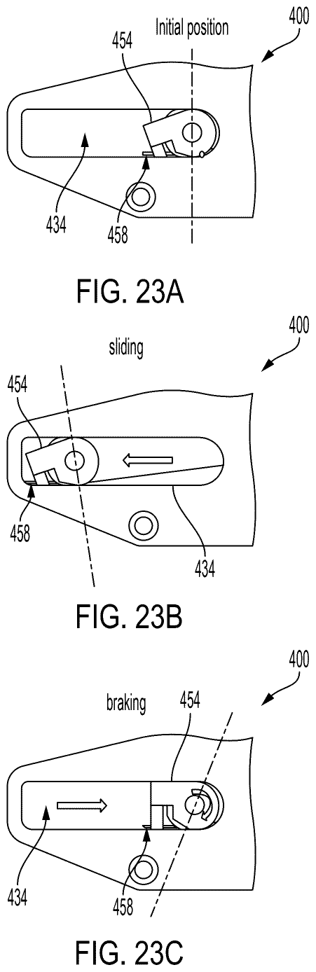

FIGS. 23A to 23C illustrate the brake lever in a standard position, belt tensioning position, and a force limiting position. The standard position is the initial position. During the belt tensioning position, the brake lever 454 rotates counterclockwise and is in a sliding position. Then, when the harness strap is pulled, the brake 454 rotates clockwise, and the full diameter of the brake 454 comes into effect, which is larger than the width of the slotted hole 434. In the force limiting position, the brake lever 454 is braking, which happens immediately when the harness strap is pulled backwards. The disc of the brake lever 454 may have an overlap of approximately 0.2 mm with the slotted hole 434 when braking. In an embodiment, the disc of brake lever 454 is not concentric with slotted hole 434. When the brake lever 454 is tensioned, the brake lever 454 is in contact with the slotted hole 434. Rotation of the brake lever 454 is supported by a leaf spring 458. Rotation of the brake can be triggered by an eccentrically positioned connection (not shown).

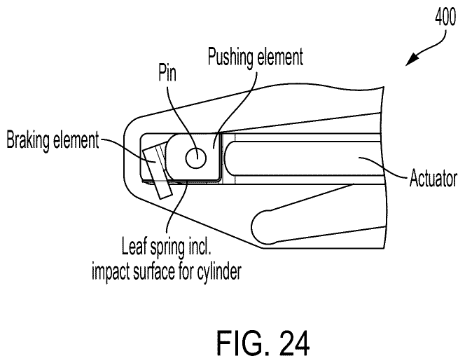

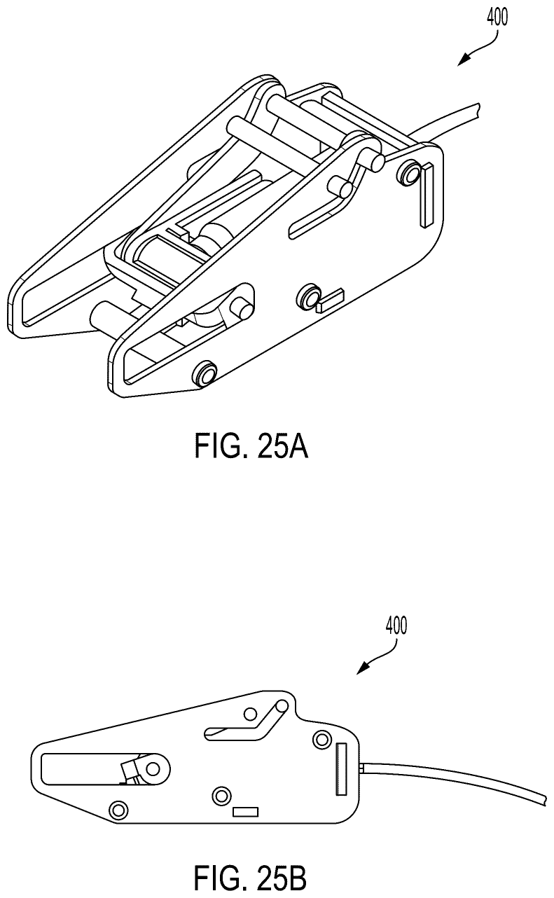

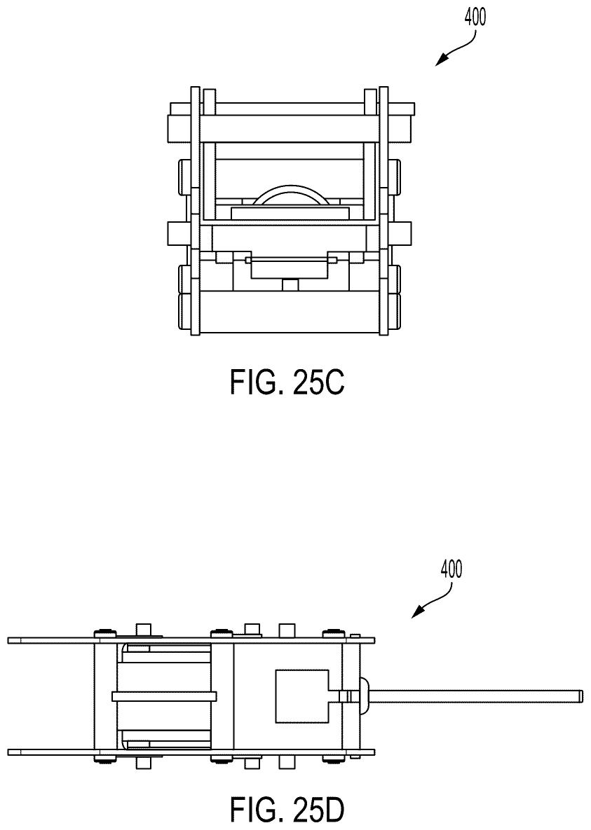

FIG. 24 illustrates a partial view of the harness belt tensioning mechanism 400 and its various components. For example, the harness belt tensioner mechanism additionally includes a braking element, a pin, a pushing element 460, an actuator, and a leaf spring 458. The leaf spring 458 is slidably coupled to the pushing element 460. FIGS. 25A to 25D illustrate schematic drawings of the harness belt tensioning mechanism described in reference to FIGS. 19 to 24B. FIG. 25A is a schematic drawing of the harness belt tensioning mechanism 400 in a standard position. FIGS. 25B to 25C are schematic drawings of a side view and a rear view of a harness belt tensioner mechanism 400, respectively. The harness belt tensioner mechanism 400 may be any suitable length, height, and width to accommodate a harness belt or strap for a child safety seat. For example, the harness belt tensioner mechanism may be 123 mm in length (not including the length of the drive module 132), 51.5 mm in height, and 46.2 mm in width. FIG. 25D is a top view of the harness belt tensioner mechanism 400.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A system for child safety seat harness belt tensioning, the system comprising,
a child safety seat,
a child safety seat harness strap, and
a harness belt tensioning assembly,
wherein the child safety seat harness strap is fixedly coupled to the child safety seat,
wherein the harness belt tensioning assembly is fixedly coupled to the child safety seat,
wherein the child safety seat harness strap is coupled to the harness belt tensioning assembly, and
wherein the harness belt tensioning assembly is configured to automatically adjust a length of the child safety seat harness strap in response to a predetermined changed in acceleration, and
wherein the harness belt tensioning assembly has a standard configuration, a belt tensioning configuration, and a force limiting configuration.

2. The system of claim 1, wherein the harness belt tensioning assembly comprises a base with side walls, an adjuster, an adjuster carriage, a connecting portion, a guide body, a force limiter, and a rolling element, wherein the base has a first end, a middle point, and a second end, wherein the adjuster carriage is located near the first end, and wherein the guide body is located near the second end.

3. The system of claim 2, wherein each side wall includes a force limiter track between the first end and the middle point, wherein each side wall includes a rolling element tooth track between the middle point and the second end, and wherein the force limiter track and the rolling element tooth track are on separate vertical planes.

4. The system of claim 3, wherein the adjuster is coupled to a top portion of the adjuster carriage, wherein the force limiter is coupled to a bottom portion of the adjuster carriage, wherein the force limiter engages with the force limiter track, such that the force limiter slides from the first end to the middle point, wherein the adjuster carriage and the adjuster slide when the adjuster slides, and wherein the child safety seat harness strap is coupled to the harness belt tensioning assembly through the adjuster, such that the child safety seat harness strap passes from the second end towards the first end via a slit on the adjuster and then loops back towards the second end so as to increase tension on the child safety seat harness strap.

5. The system claim of claim 4, wherein the rolling portion is coupled to a top portion of the guide body, wherein teeth on the rolling portion engage with the rolling element tooth track, such that the rolling portion translates from the second end to the middle point, and wherein guide body translates when the rolling portion translates.

6. The system of claim 5, wherein the guide body comprises a drive module, wherein the drive module comprises a pyrotechnic module configured to move the drive module towards the middle point, and wherein the pyrotechnic module is activated when sensors detect a threshold level of vehicle acceleration.

7. The system of claim 6, wherein in the standard configuration the adjuster carriage is in a position closest to the first end and furthest from the middle point, and wherein the guide body is in a position closest to the second end and furthest from the middle point.

8. The system of claim 6, wherein in the belt tensioning configuration the pyrotechnic module is activated when sensors detect a threshold level of vehicle acceleration to move the drive module towards the middle point, wherein a plurality of tooth elements on the underside of the drive module couple with the connecting portion so as to prevent the guide body from moving back towards the second end, wherein the drive module concurrently selectively couples with the adjuster carriage, and wherein the child safety seat harness strap unwinds from the second end towards the first end a first time.

9. The system of claim 7, wherein in the force limiting configuration the child safety seat harness strap pulls the adjuster carriage and force limiter towards the middle point, wherein concurrently the child safety seat harness strap unwinds from the second end towards the first end a second time, and wherein the child safety seat harness strap increases in tension.

10. A harness belt tensioning assembly, the harness belt tensioning assembly comprising:
a base with side walls,
an adjuster,
an adjuster carriage,
a connecting portion,
a guide body, a force limiter, and
a rolling element,
wherein the base has a first end, a middle point, and a second end,
wherein the adjuster carriage is located near the first end, and wherein the guide body is located near the second end.

11. The assembly of claim 10, wherein a child safety seat harness strap is fixedly coupled to a child safety seat, wherein the harness belt tensioning assembly is fixedly coupled to the child safety seat, wherein a child safety seat harness strap is coupled to the harness belt tensioning assembly, and wherein the harness belt tensioning assembly is configured to automatically adjust a length of the child safety seat harness strap in response to a predetermined changed in acceleration, and wherein the harness belt tensioning assembly has a standard configuration, a belt tensioning configuration, and a force limiting configuration.

12. The assembly of claim 11, wherein each side wall includes a force limiter track between the first end and the middle point, wherein the each side wall includes a rolling element tooth track between the middle point and the second end, and wherein the force limiter track and the rolling element tooth track are on separate vertical planes.

13. The assembly of claim 12, wherein the adjuster is coupled to a top portion of the adjuster carriage, wherein the force limiter is coupled to a bottom portion of the adjuster carriage, wherein the force limiter engages with the force limiter track, such that the force limiter slides from the first end to the middle point, wherein adjuster carriage and adjuster slide when the adjuster slides, and wherein the child safety seat harness strap is coupled to the harness belt tensioning assembly through the adjuster, such that the child safety seat harness strap passes from the second end towards the first end via a slit on the adjuster and then loops back towards the second end so as to increase the tension on the child safety seat harness strap.

14. The assembly claim of claim 13, wherein the rolling portion is coupled to a top portion of the guide body, wherein teeth on the rolling portion engage with the rolling element tooth track, such that the rolling portion translates from the second end to the middle point, and wherein guide body translates when the rolling portion translates.

15. The assembly of claim 14, wherein the guide body comprises a drive module, wherein the drive module comprises a pyrotechnic module configured to move the drive module towards the middle point, and wherein the pyrotechnic module is activated when sensors detect a threshold level of vehicle acceleration.

16. The assembly of claim 15, wherein in the standard configuration the adjuster carriage is in a position closest to the first end and furthest from the middle point, and wherein the guide body is in a position closest to the second end and furthest from the middle point.

17. The assembly of claim 15, wherein in the belt tensioning configuration the pyrotechnic module is activated when sensors detect a threshold level of vehicle acceleration to move the drive module towards the middle point, wherein a plurality of tooth elements on the underside of the drive module couple with the connecting portion so as to prevent the guide body from moving back towards the second end, wherein the drive module concurrently selectively couples with the adjuster carriage, and wherein the child safety seat harness strap unwinds from the second end towards the first end a first time.

18. The assembly of claim 16, wherein in the force limiting configuration the child safety seat harness strap pulls the adjuster carriage and force limiter towards the middle point, wherein concurrently the child safety seat harness strap unwinds from the second end towards the first end a second time, and wherein the child safety seat harness strap increases in tension.

19. A method of using a harness belt tensioning assembly on a child safety seat, the harness belt tensioning assembly comprising a base with side walls, an adjuster, an adjuster carriage, a connecting portion, a guide body, a force limiter, and a rolling element, where the base has a first end, a middle point, and a second end, wherein the adjuster carriage is located near the first end, where the guide body is located near the second end, where a child safety seat harness strap is fixedly coupled to a child safety seat, where the harness belt tensioning assembly is fixedly coupled to the child safety seat, and where a child safety seat harness strap is coupled to the harness belt tensioning assembly, the method comprising:
detecting acceleration,
determining acceleration meets or exceeds a predetermined threshold,
activating a pyrotechnic module on the guide body,
moving the guide body from the second end to the middle point towards the adjuster carriage,
connecting the guide body with the adjuster carriage, and
unwinding the child safety seat harness strap a first time.

20. The method of claim 19, further comprising the child safety seat harness strap pulling the adjuster carriage and force limiter towards the middle point, and concurrently unwinding the child safety seat harness strap unwinds from the second end towards the first end a second time, wherein the child safety seat harness strap increases in tension.
